(19) United States
(12) Patent Application Publication
(10) Pub. No.: US 2006/0143014 A1
(43) Pub. Date: Jun. 29, 2006

(54) [ADAPTER]

(75) Inventors: Chiu-Hao Cheng, TAIPEI (TW); Ming-Kuo Cheng, TAIPEI (TW)

Correspondence Address: ZEROPLUS TECHNOLOGY CO., LTD., 2F-4, NO. 184, SEC. 4, CHUNG HSIAO EAST ROAD, TAIPEI, TW

(73) Assignee: ZEROPLUS TECHNOLOGY CO., LTD., Chungho City, Taipei Hsien (TW)

(21) Appl. No.: 10/905,303

(22) Filed: Dec. 27, 2004

(51) Int. Cl. G10L 21/00

(52) U.S. Cl. 704/270

(57) ABSTRACT

An adapter is disclosed to include a casing holding a webcam and a microphone for picking up images and voices from the display and speaker of a first electronic apparatus, and an A/V (audio/video) transmitting interface connected to the AV (audio/video) receiving interface of a second electronic apparatus and controlled by a control circuit in the casing to transmit audio and video signals obtained from the first electronic apparatus to the AV (audio/video) receiving interface of the second electronic apparatus for output through the display and speaker of the second electronic apparatus.

### BACKGROUND OF THE INVENTION

1. Field of the Invention

The present invention relates to an adapter for communication between two electronic apparatus, for enabling the user to see the images of the display of the first electronic apparatus and to hear the voices of the speaker of the first electronic apparatus through the display and speaker of the second electronic apparatus.

2. Description of the Related Art

Information and electronics are the most important industries in technology in 21 centuries. Many countries around the world encourage their people to develop technology in order to have advantage of others in economics. Following this trend, a variety of advances and sophisticated electronic apparatus have been continuously developed. It is the market requirements for modern electronics having the characteristics of light, thin, short, small, and high precision. From early heavy telephone set to the current handy mobile phone, high technology greatly changes our living style. A mobile phone allows free communication at all times and places. Nowadays, an advanced mobile phone has many added functions including E-mail, video game, calculator, and etc. Every electronic communication apparatus suppliers keep trying hard to provide advanced products with added functions to attract consumers.

In order to attract consumers, mobile phone manufacturers keep designing fun video games for playing through their mobile phones. However, one may be unable to see the images and to hear the voices well when playing a video game through a mobile phone. In order to let the user see images clearly, the size of the display screen of the mobile phone must be increased. However, the market requirements for modern electronics having the characteristics of light, thin, short, small, and high precision does not allow mobile phone manufacturers to provide big size mobile phones.

### SUMMARY OF THE INVENTION

The present invention has been accomplished under the circumstances in view. It is therefore the main object of the present invention to provide an adapter, which is connectable between two electronic apparatus, for enabling the user to see and hear images and voices of the first electronic apparatus through the second electronic apparatus. To achieve this and other objects of the present invention, the adapter comprises a casing, a webcam mounted in the casing and adapted to pick up images of the display means of the first electronic apparatus, a microphone mounted in the casing and adapted to pick up voices of the speaker means of the first electronic apparatus, a positioning device for fastening the casing to the first electronic apparatus, a connecting device connected between the casing and the positioning device to support the casing on the positioning device, an A/V (audio/video) transmitting interface connected to the A/V (audio/video) receiving interface of the second electronic apparatus, and a control circuit adapted to transmit video signal obtained from the webcam and audio signal obtained from the microphone to the A/V (audio/video) receiving interface of the second electronic apparatus through the A/V (audio/video) transmitting interface for output through the display means and speaker means of the second electronic apparatus.

### BRIEF DESCRIPTION OF THE INVENTION

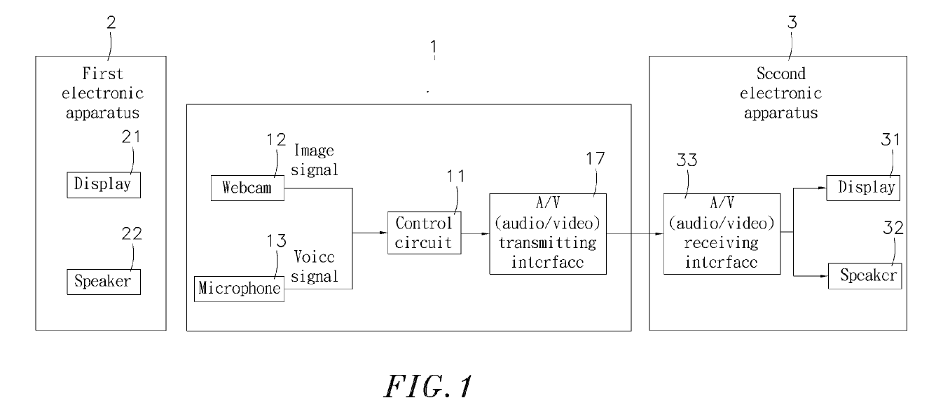

FIG. 1 is system block diagram of a first embodiment of the present invention.

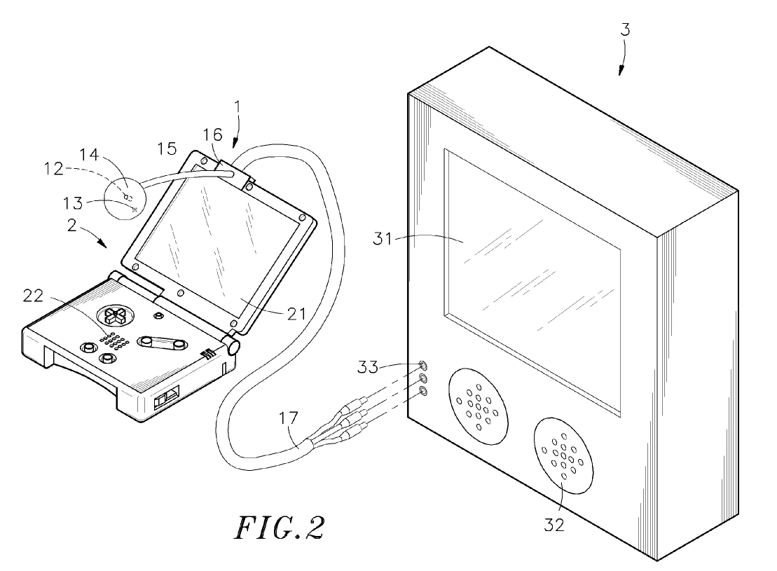

FIG. 2 is a perspective view showing an application example of the first embodiment of the present invention.

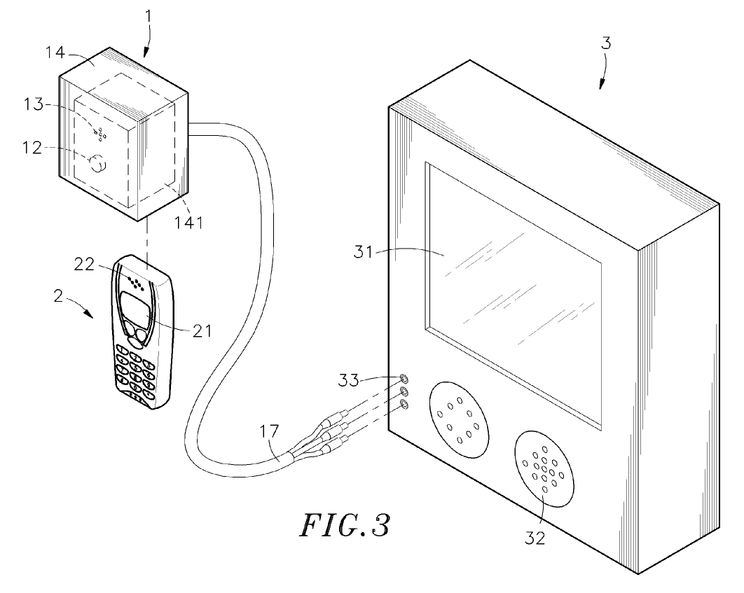

FIG. 3 is a perspective view showing an application example of a second embodiment of the present invention.

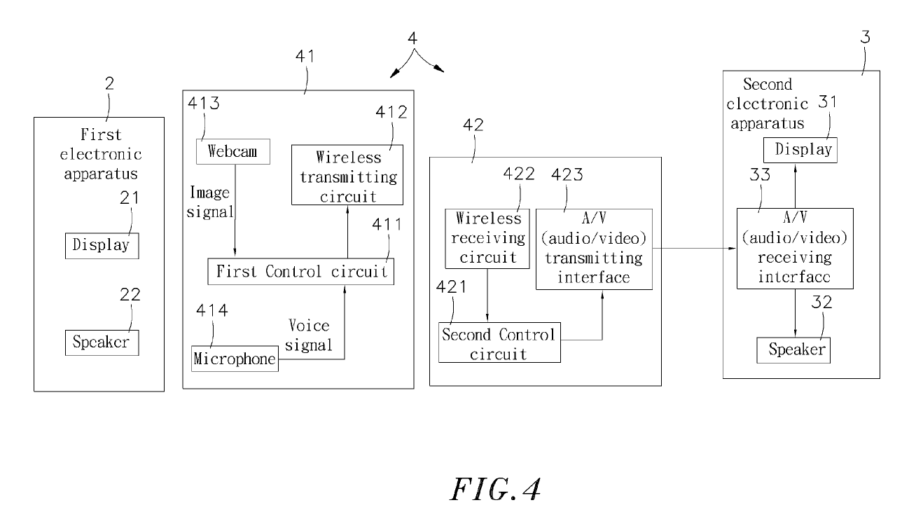

FIG. 4 is a system block diagram of a third embodiment of the present invention.

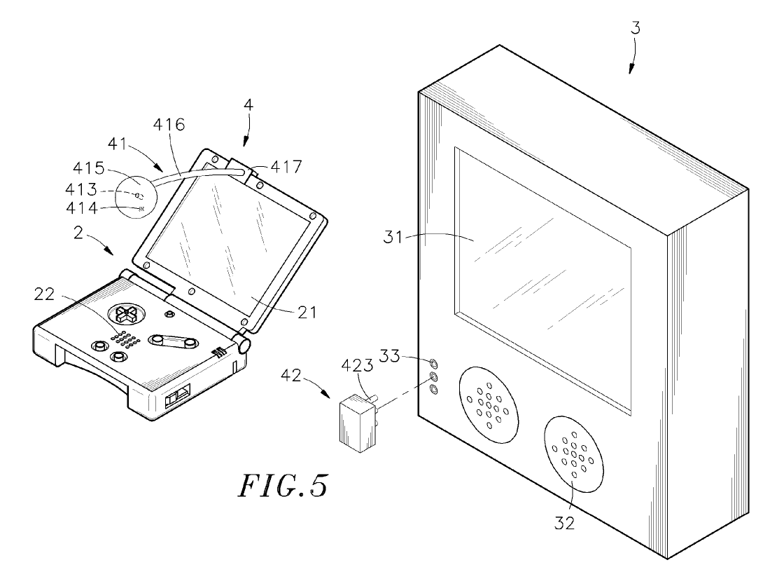

FIG. 5 is a perspective view showing an application example of the third embodiment of the present invention.

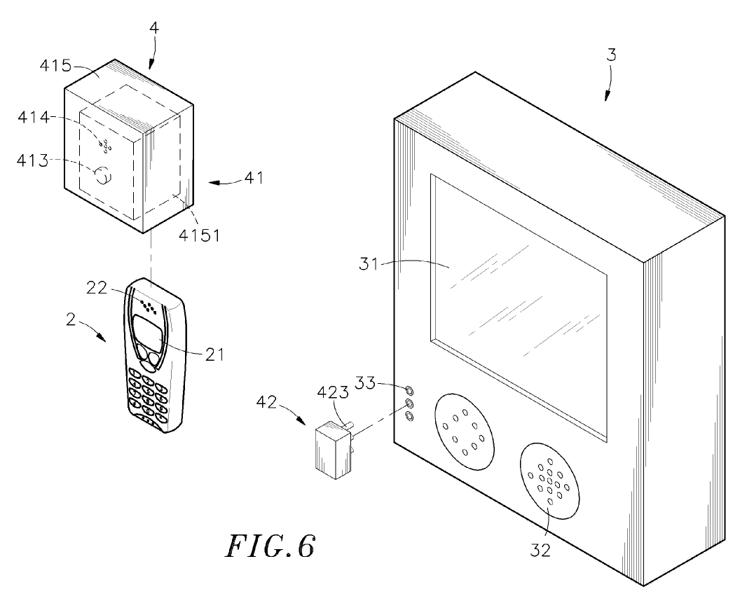

FIG. 6 is a perspective view showing an application example of a fourth embodiment of the present invention.

### DETAILED DESCRIPTION OF THE EMBODIMENT

Referring to FIG. 1, an adapter 1 in accordance with the first embodiment of the present invention is shown for communication between a first electronic apparatus 2 and a second electronic apparatus 3, comprising a control circuit 11, a webcam 12, a microphone 13, and an A/V (audio/video) transmitting interface 17. The first electronic apparatus 2 comprises a display 21 for video output, and a speaker 22 for audio output. The second electronic apparatus 3 comprises a display 31 for video output, a speaker 32 for audio output, and an A/V (audio/video) receiving interface 33. The display 31 and the speaker 32 are respectively electrically connected to the A/V (audio/video) receiving interface 33.

The control circuit 11 is connectable to the A/V (audio/video) receiving interface 33 of the second electronic apparatus 3 through the A/V (audio/video) transmitting interface 17. The webcam 12 is electrically connected to the control circuit 11, and controlled by the control circuit 11 to continuously pick up images of the display 21 of the first electronic apparatus 2 and to transmit obtained image signal to the control circuit 11, which in turn converts received image signal into video signal readable to the second electronic apparatus 3 and then transmits video signal to the A/V (audio/video) receiving interface 33 of the second electronic apparatus 3 through the A/V (audio/video) transmitting interface 17 for output through the display 31. Therefore, images displayed on the display 21 of the first electronic apparatus 2 can be seen on the display 31 of the second electronic apparatus 3.

The microphone 13 is electrically connected to the control circuit 11, and controlled by the control circuit 11 to pick voices outputted through the speaker 22 and to transmit obtained voice signal to the control circuit 11, which in turn converts received voice signal into audio signal readable to the second electronic apparatus 3 and then transmits audio signal to the A/V (audio/video) receiving interface 33 of the second electronic apparatus 3 through the A/V (audio/video) transmitting interface 17 for output through the speaker 32. Therefore, voices outputted through the speaker 22 of the first electronic apparatus 2 can be heard from the speaker 32 of the second electronic apparatus 3.

When the user using the webcam 12 and microphone 13 of the adapter 1 to pick up images and voices from the display 21 and speaker 22 of the first electronic apparatus 2, the webcam 12 and the microphone 13 will continuously pick up images and voices from the display 21 and the speaker 22 and transmit obtained image and voice signals to the control circuit 11, and the control circuit 11 will convert received image and voice signals into video and audio signals readable to the second electronic apparatus 3 and then transmit converted video and audio signals to the A/V (audio/video) receiving interface 33 of the second electronic apparatus 3 through the A/V (audio/video) transmitting interface 17 for output through the display 31 and speaker 32 of the second electronic apparatus 3 respectively.

Referring to FIG. 2 and FIG. 1 again, the adapter 1 according to the first embodiment of the present invention further comprises a casing 14 accommodating the control circuit 11, the webcam 12 and the microphone 13, a positioning device 16 for fastening to the first electronic apparatus 2, a connecting device 15 connected between the casing 14 and the positioning device 16. The connecting device 15 may be formed of a flexible tube or adjustable support means capable of supporting the weight of the casing 14 for enabling the user to adjust the casing 14 to the desired direction and angle where the webcam 12 and the microphone 13 can continuously pick up images and voices from the display 21 and speaker 22 of the first electronic apparatus 2 and transmit obtained image and voice signals to the control circuit 11, for enabling the control circuit 11 to convert received image and voice signals into video and audio signals readable to the second electronic apparatus 3 and then to transmit converted video and audio signals to the A/V (audio/video) receiving interface 33 of the second electronic apparatus 3 through the A/V (audio/video) transmitting interface 17 for output through the display 31 and speaker 32 of the second electronic apparatus 3 respectively. Further, the positioning device 16 can be a clip. The first electronic apparatus 2 can be a cell phone, PDA (personal digital assistant), mobile CD/VCD/DVD player, palmtop game machine, or any of a variety of electronic apparatus equipped with video display means without A/V (audio/video) transmitting interface means. The second electronic apparatus 3 can be a TV set, computer system, monitor, projector, or any of a variety of electronic apparatus equipped with video display means and an A/V (audio/video) receiving interface means.

FIG. 3 shows an adapter 1 according to the second embodiment of the present invention. According to this embodiment, the adapter 1 comprises a casing 14 accommodating a control circuit 11 (not shown), a webcam 12 and a microphone 13 and connectable to a first electronic apparatus 2, and A/V (audio/video) transmitting interface 17 made in the form of a cable and connectable to the A/V (audio/video) receiving interface 33 of a second electronic apparatus 3. The casing 14 has a socket 141 for receiving the first electronic apparatus 2. After insertion of the first electronic apparatus 2 into the socket 141, the webcam 12 and the microphone 13 continuously pick up images and voices from the display 21 and speaker 22 of the first electronic apparatus 2 and transmit obtained image and voice signals to the control circuit 11, for enabling the control circuit 11 to convert received image and voice signals into video and audio signals readable to the second electronic apparatus 3 and then to transmit converted video and audio signals to the A/V (audio/video) receiving interface 33 of the second electronic apparatus 3 through the A/V (audio/video) transmitting interface 17 for output through the display 31 and speaker 32 of the second electronic apparatus 3 respectively. Because the first electronic apparatus 2 is inserted into the socket 141 of the casing 14 and the webcam 12 picks up images from the display 21 of the first electronic apparatus 2 in the socket 141, images of the display 21 are free from the interference of surrounding light sources, and therefore good quality images can be seen on the display 31 of the second electronic apparatus 3.

FIG. 4 is a system block diagram of an adapter 4 according to the third embodiment of the present invention. According to this embodiment, the adapter 4 comprises a wireless transmitter unit 41 and a wireless receiver unit 42. The wireless transmitter unit 41 comprises a webcam 413 adapted to pick up images displayed on the display 21 of a first electronic apparatus 2, a microphone 414 adapted to pick voices from the speaker 22 of the first electronic apparatus 2, a first control circuit 411 electrically connected to the webcam 413 and the microphone 414 and adapted to convert received image signal and voice signal into video signal and audio signal readable to a second electronic apparatus 3, and a wireless transmitting circuit 412 electrically connected to the fist control circuit 411 and adapted to modulate video signal and audio signal outputted from the first control circuit 411 and transmit modulated video signal and audio signal to the wireless receiver unit 42 wirelessly. The wireless receiver unit 42 comprises a wireless receiving circuit 422 adapted to receive modulated video signal and audio signal from the wireless transmitting circuit 412 and demodulate received modulated video signal and audio signal, an A/V (audio/video) transmitting interface 423 connected to the A/V (audio/video) receiving interface 33 of the second electronic apparatus 3, and a second control circuit 421 adapted to control the A/V (audio/video) transmitting interface 423 to transmit demodulated video signal and audio signal to the A/V (audio/video) receiving interface 33 of the second electronic apparatus 3 for output through the display 31 and speaker 32 of the second electronic apparatus 3.

Referring to FIG. 5 and FIG. 4 again, the wireless transmitter unit 41 of the adapter 4 further comprises a casing 415 accommodating the first control circuit 411, the wireless transmitting circuit 412, the webcam 413 and the microphone 414, a positioning device 417 for fastening to the first electronic apparatus 2, and a connecting device 416 connected between the casing 415 and the positioning device 417. The connecting device 416 may be formed of a flexible tube or adjustable support means capable of supporting the weight of the casing 415 for enabling the user to adjust the casing 415 to the desired direction and angle. Further, the positioning device 417 can be a clip. The first electronic apparatus 2 can be a cell phone, PDA (personal digital assistant), mobile CD/VCD/DVD player, palmtop game machine, or any of a variety of electronic apparatus equipped with video display means without A/V (audio/video) transmitting interface means. The second electronic apparatus 3 can be a TV set, computer system, monitor, projector, or any of a variety of electronic apparatus equipped with video display means and an A/V (audio/video) receiving interface means.

FIG. 6 shows an adapter 4 according to the fourth embodiment of the present invention. The circuit block diagram of this embodiment is same as that shown in FIG. 4. According to this embodiment, the adapter 4 comprises a wireless transmitter unit 41 and a wireless receiver unit 42. The wireless transmitter unit 41 comprises a casing 415 accommodating a first control circuit 411 (not shown), a wireless transmitting circuit 412 (not shown), a webcam 413 and a microphone 414. The casing 415 has a socket 4151 for receiving the first electronic apparatus 2. After insertion of the first electronic apparatus 2 into the socket 4151, the webcam 413 and the microphone 414 continuously pick up images and voices from the display 21 and speaker 22 of the first electronic apparatus 2 and transmit obtained image and voice signals to the first control circuit 411, for transmitting to the wireless receiver unit 42 wirelessly through the wireless transmitting circuit 412. The wireless transmitter unit 42 according to this embodiment is same as the aforesaid third embodiment shown in FIG. 5. Because the first electronic apparatus 2 is inserted into the socket 4151 of the casing 415 and the webcam 413 picks up images from the display 21 of the first electronic apparatus 2 in the socket 4151, images of the display 21 are free from the interference of surrounding light sources, and therefore good quality images can be seen on the display 31 of the second electronic apparatus 3.

A prototype of adapter has been constructed with the features of FIGS. 1˜6. The adapter functions smoothly to provide all of the features discussed earlier.

Although particular embodiments of the invention has been described in detail for purposes of illustration, various modifications and enhancements may be made without departing from the spirit and scope of the invention. Accordingly, the invention is not to be limited except as by the appended claims.

What is claimed is:

1. An adapter for communication between a first electronic apparatus, which has display means and speaker means, and a second electronic apparatus, which has display means and speaker means and A/V (audio/video) receiving interface means, the adapter comprising a casing, a webcam mounted in said casing and adapted to pick up images of the display means of said first electronic apparatus, a positioning device for fastening said casing to said first electronic apparatus, a connecting device connected between said casing and said positioning device to support said casing on said positioning device, an A/V (audio/video) transmitting interface connected to the A/V (audio/video) receiving interface of said second electronic apparatus, and a control circuit adapted to transmit video signal obtained from said webcam to the A/V (audio/video) receiving interface of said second electronic apparatus through said A/V (audio/video) transmitting interface for output through the display means of said second electronic apparatus.

2. The adapter as claimed in claim 1, further comprising a microphone mounted in said casing and electrically connected to said control circuit and adapted to pick up voices of the speaker means of said first electronic apparatus for enabling obtained voice signal to be transmitted by said control circuit to said second electronic apparatus through said A/V (audio/video) transmitting interface.

3. The adapter as claimed in claim 1, wherein said casing comprises a socket for receiving said first electronic apparatus.

4. The adapter as claimed in claim 1, wherein said connecting device is a flexible tube or adjustable support means.

5. The adapter as claimed in claim 1, wherein said positioning device is a clip.

6. The adapter as claimed in claim 1, wherein said first electronic apparatus is one of the product group of cell phone, palmtop game machine, PDA, and mobile CD/VCD/DVD player.

7. The adapter as claimed in claim 1, wherein said second electronic apparatus is one of the product group of TV set, computer system, monitor, and projector.

8. An adapter for communication between a first electronic apparatus, which has display means and speaker means, and a second electronic apparatus, which has display means and speaker means and A/V (audio/video) receiving interface means, the adapter comprising:
a wireless transmitter unit, said wireless transmitter unit comprising a casing, a webcam mounted in said casing and adapted to pick up images of the display means of said first electronic apparatus, positioning device for fastening said casing to said first electronic apparatus, a connecting device connected between said casing and said positioning device to support said casing on said positioning device, a wireless transmitting circuit, and a first control circuit electrically connected between said webcam and said wireless transmitting circuit and adapted to transmit video signal obtained from said webcam into the air through said wireless transmitting circuit; and
a wireless receiver unit, said wireless receiver unit comprising a wireless receiving circuit adapted to receive wireless video signal from said wireless transmitter unit, an A/V (audio/video) transmitting interface connected to the A/V (audio/video) receiving interface of said second electronic apparatus, and a second control circuit electrically connected between said wireless receiving circuit and said A/V (audio/video) transmitting interface and adapted to transmit video signal received from said wireless transmitter unit through said wireless receiving circuit to the A/V (audio/video) receiving interface of said second electronic apparatus through said A/V (audio/video) transmitting interface for output through the display means of said second electronic apparatus.

9. The adapter as claimed in claim 8, wherein said wireless transmitter unit further comprises a microphone mounted in said casing and electrically connected to the first control circuit of said wireless transmitter unit and adapted to pick up voices of the speaker means of said first electronic apparatus for enabling obtained voice signal to be transmitted by the first control circuit of said wireless transmitter unit through said wireless transmitting circuit to said wireless receiver unit for output through the speaker means of said second electronic apparatus.

10. The adapter as claimed in claim 8, wherein said casing comprises a socket for receiving said first electronic apparatus.

11. The adapter as claimed in claim 8, wherein said connecting device is a flexible tube or adjustable support means.

12. The adapter as claimed in claim 8, wherein said positioning device is a clip.

13. The adapter as claimed in claim 8, wherein said first electronic apparatus is one of the product group of cell phone, palmtop game machine, PDA, and mobile CD/VCD/DVD player.

14. The adapter as claimed in claim 8, wherein said second electronic apparatus is one of the product group of TV set, computer system, monitor, and projector.
